(19) United States
(12) Patent Application Publication
(10) Pub. No.: US 2023/0323802 A1
(43) Pub. Date: Oct. 12, 2023

(54) EXHAUST GAS TREATMENT SYSTEM

(71) Applicants: Johnson Matthey Public Limited Company, London (GB); Johnson Matthey Catalysts (Germany) GmbH, Redwitz an der Rodach (DE)

(72) Inventors: Christopher DALY, Royston (GB); Rainer LEPPELT, Redwitz an der Rodach (DE); Joerg Werner MUENCH, Redwitz an der Rodach (DE); Andrew David NEWMAN, Royston (GB); Irene PIRAS, Redwitz an der Rodach (DE); Agnes RAJ, Reading (GB); Dominic Florian SANTI, Redwitz an der Rodach (DE); Nicholas SPENCER, Royston (GB); Andrew STONOR, Royston (GB)

(21) Appl. No.: 18/132,591

(22) Filed: Apr. 10, 2023

Related U.S. Application Data
(60) Provisional application No. 63/362,681, filed on Apr. 8, 2022.

(51) Int. Cl. F01N 3/28; B01J 23/22; B01J 23/30; B01J 23/38; B01J 29/76; B01J 21/06; B01J 21/08; B01J 23/10; B01J 35/04; B01J 35/00; F01N 3/20; F01N 3/10; B01D 53/94

(52) U.S. Cl. CPC F01N 3/2825; B01J 23/22; B01J 23/30; B01J 23/38; B01J 29/763; B01J 21/063; B01J 21/08; B01J 23/10; B01J 35/04; B01J 35/0006; F01N 3/2066; F01N 3/106; B01D 53/9418; B01D 53/944; B01D 53/9472; B01D 53/9477; B01D 53/9436; F01N 2610/1453; F01N 2370/04; F01N 2330/48; B01D 2258/012; B01D 2255/20723; B01D 2255/2065; B01D 2255/2098; B01D 2255/9155; B01D 2255/9032; B01D 2255/9035; B01D 2255/50; B01D 2251/2062

(57) ABSTRACT

An exhaust gas treatment system includes in order: an intake for receiving an exhaust gas from a lean burn combustion engine; an injector for the provision of a nitrogenous reductant; a close-coupled vanadium-containing SCR catalyst composition; one or more downstream PGM-containing oxidation catalyst compositions, wherein the close-coupled vanadium-containing SCR catalyst composition includes cerium in a Ce:V molar ratio of greater than 0.3.

### BACKGROUND OF THE INVENTION

The present invention relates to an exhaust gas treatment system and method for treating exhaust gas and, in particular, to one which employs a close-coupled vanadium-containing SCR catalyst composition having high SCR activity without compromising the activity of a downstream PGM-containing oxidation catalyst composition, which may additionally comprise a Cu— zeolite.

Emission legalisation due to come into effect in Europe from 2025 (Euro 7) requires tighter control of NOx and N₂O release.

In order to meet the requirements of Euro 7 legislation, it is desirable to use vanadium-containing SCR catalysts, due to their lower selectivity to N₂O compared to copper zeolites. In particular, it would be desirable to arrange the vanadium-containing SCR catalyst in the close-coupled position where it would be rapidly heated by exhaust gas after switch on (i.e. after engine start-up), thereby enabling the catalyst to reach its light-off temperature quickly. Using greater amounts of vanadium in such catalysts improves their SCR activity. In particular, using greater amounts of vanadium in such catalysts improves their activity for reduction of NO. This is particularly, important when the vanadium-containing SCR catalyst is arranged in the close-coupled position where little NO₂ is present and so the majority of its performance is in respect of reduction of NO. In known arrangements, the catalyst support material may be stabilised so that greater amounts of vanadium can be employed. In some cases, antimony is used to stabilise a titania-based support material. However, increasing the vanadium content leads to a greater potential for volatilisation and subsequent loss of vanadium from the SCR catalyst during use, especially when the SCR catalyst is in the hot close-coupled position. The loss of vanadium from the close-coupled SCR catalyst is a particular problem for downstream PGM-containing oxidation catalysts, such as DOCs or ASCs, particularly those also containing copper-zeolites, which are poisoned by the released vanadium thereby reducing their activity.

Accordingly, there is a desire for the provision of an improved exhaust gas treatment system employing a close-coupled SCR catalyst composition together with downstream PGM containing oxidation catalyst compositions that demonstrates high NOx activity and low N₂O selectivity, without compromising its oxidation activity so that the requirements of Euro 7 legislation may be met. It is an object of the present invention to address this problem, tackle the disadvantages associated with the prior art, or at least provide a commercially useful alternative thereto.

### SUMMARY OF THE INVENTION

According to certain aspects of the present invention, an exhaust gas treatment system comprises, in order:
an intake for receiving an exhaust gas from a lean burn combustion engine;
an injector for the provision of a nitrogenous reductant;
a close-coupled vanadium-containing SCR catalyst composition;
one or more downstream PGM-containing oxidation catalyst compositions,
wherein the close-coupled vanadium-containing SCR catalyst composition comprises cerium in a Ce:V molar ratio of greater than 0.3.

In some aspects, vanadium is present in the close-coupled vanadium-containing SCR catalyst composition in an amount of at least 2 wt %, or 2-6 wt %, on a V₂O₅ basis. The close-coupled vanadium-containing SCR catalyst composition may further comprise antimony in an Sb:V molar ratio of greater than 0.5, or 0.6-0.9. Cerium may be present in the close-coupled vanadium-containing SCR catalyst composition in a Ce:V molar ratio of 0.3 to 0.7, or 0.4 to 0.6.

In some aspects, the close-coupled vanadium-containing SCR catalyst composition is provided as an extruded porous substrate or a washcoat on a porous substrate. The extruded porous substrate or the porous substrate may be a honeycomb monolith substrate.

In some aspects, the close-coupled vanadium-containing SCR catalyst composition comprises a titania-based catalyst support material.

In certain aspects, a downstream PGM-containing oxidation catalyst compositions is provided as an extruded porous substrate or a washcoat on a substrate.

In some aspects, the one or more downstream PGM-containing oxidation catalyst composition(s) are provided on and/or in the same substrate as the close-coupled vanadium-containing SCR catalyst composition forming a single catalyst article, wherein the substrate has an inlet end, an outlet end and an axial length. The close-coupled vanadium-containing SCR catalyst composition may be arranged in a first region and the one or more downstream PGM-containing oxidation catalyst composition(s) is arranged in a second region, wherein the first region is spaced apart from the second region. In some aspects, the first region extends from the inlet end and wherein the second region extends from the outlet end, optionally wherein the first region extends along between 10% and 90% of the axial length of the substrate, 25 to 85% of the axial length of the substrate and the second region extends along between 10% and 90% of the axial length of the substrate, 10 to 60% of the axial length of the substrate. In certain aspects, the first and second regions do not overlap such that there is a gap along the axial length of the substrate between the first and second regions, optionally wherein the first region is a first layer and wherein the second region is a second layer.

The system may further comprise a covering layer extending from the outlet end over at least part of the second region, optionally wherein the covering layer comprises a SCR catalyst composition. In some aspects, the first region is a first layer and wherein the second region is a second layer, wherein the first and second regions are spaced apart from each other by an intervening layer extending between the first and second layers, optionally wherein the intervening layer comprises a SCR catalyst composition. In some aspects, the first layer overlaps with the second layer.

In certain aspects, the close-coupled vanadium-containing SCR catalyst composition and the one or more PGM-containing oxidation catalyst compositions are provided on separate substrates thereby forming a close-coupled vanadium-containing SCR catalyst article and one or more PGM-containing oxidation catalyst articles, optionally wherein the close-coupled vanadium-containing SCR catalyst article is spaced apart from the one or more PGM-containing oxidation catalyst articles.

In some aspects, the downstream PGM-containing oxidation catalyst composition(s) comprise an ASC composition and a DOC composition, wherein the ASC composition is upstream of the DOC composition.

In certain aspects, the system further comprises a downstream SCR catalyst composition downstream of the one or more PGM-containing oxidation catalyst composition(s), optionally wherein the one or more PGM-containing oxidation catalyst composition(s) and the downstream SCR catalyst composition are in an SCRT® configuration.

In some aspects, the one or more downstream PGM-containing oxidation catalyst composition(s) further comprises a Cu-zeolite, wherein the Cu-zeolite is a small-pore zeolite, preferably wherein the Cu-zeolite has a CHA or AEI-type framework structure.

According to some aspects of the present invention, a combustion and exhaust treatment system, comprises
a lean burn combustion engine; and
the exhaust gas treatment system as described herein.

According to some aspects of the present invention, a method for the treatment of an exhaust gas comprises treating an exhaust gas in the exhaust gas treatment system described herein.

According to certain aspects, the present invention includes use of cerium to reduce vanadium-loss from a close-couple vanadium-containing SCR catalyst composition, wherein the close-coupled vanadium-containing SCR catalyst composition comprises cerium in a Ce:V molar ratio of greater than 0.3.

### BRIEF DESCRIPTION OF FIGURES

FIG. 1 shows a first exemplary configuration of a catalyst article according to the invention.

FIG. 2 shows a second exemplary configuration of a catalyst article according to the invention.

FIG. 3 shows a third exemplary configuration of a catalyst article according to the invention.

FIG. 4 is a schematic diagram of the arrangement employed to test the loss of vanadium from the vanadium-containing SCR catalysts of Examples 1 to 27.

FIG. 5 is a graph demonstrating the reduced loss of vanadium from a vanadium-containing SCR due to the presence of cerium in the catalyst, which was provided as a washcoat on a substrate. The data shown in the graph of FIG. 5 has been normalised.

FIG. 6 is a graph demonstrating maintained NOx activity achieved despite the presence of cerium in a vanadium-containing SCR catalyst, which was provided as a washcoat on a substrate.

FIG. 7 is a graph demonstrating the effect of cerium loading on vanadium loss from an extruded vanadium containing SCR catalyst and from a vanadium containing catalyst formed as a washcoat on a substrate. The data for Examples 7 to 14 have been normalised relative to the data for Example 7 and the data for Examples 15 to 18 have been normalised relative to the data for Example 15.

FIG. 8 is a graph of vanadium loading of the vanadium-containing SCR catalyst against vanadium loss therefrom and demonstrates reduced loss of vanadium at different vanadium loadings, due to the presence of cerium in the catalyst.

FIG. 9 is a different representation of the data used in the graph of FIG. 5. In FIG. 6, the graph is of molar ratio of the added metal:vanadium where the added metal is cerium, tungsten or niobium against vanadium loss from the vanadium-containing SCR catalyst.

FIG. 10 is a graph demonstrating improved fresh NOx activity at 225° C. achieved with higher vanadium loading despite the presence of cerium in the vanadium-containing SCR catalyst.

FIG. 11 is a graph demonstrating improved aged NOx activity at 225° C. achieved with higher vanadium loading despite the presence of cerium in the vanadium-containing SCR catalyst.

FIG. 12 is a graph demonstrating improved fresh NOx activity at 500° C. with higher vanadium loading achieved despite the presence of cerium in the vanadium-containing SCR catalyst.

### DETAILED DESCRIPTION

According to a first aspect there is provided an exhaust gas treatment system comprising, in order:
an intake for receiving an exhaust gas from a lean burn combustion engine;
an injector for the provision of a nitrogenous reductant;
a close-coupled vanadium-containing SCR catalyst composition;
one or more downstream PGM-containing oxidation catalyst composition(s),
wherein the close-coupled vanadium-containing SCR catalyst composition comprises cerium in a Ce:V molar ratio of greater than 0.3.

In the following passages different aspects/embodiments are defined in more detail. Each aspect/embodiment so defined may be combined with any other aspect/embodiment or aspects/embodiments unless clearly indicated to the contrary. In particular, any feature indicated as being preferred or advantageous may be combined with any other feature or features indicated as being preferred or advantageous.

As discussed above, in order to meet the requirements of Euro 7 legislation, it would be desirable to use close-coupled vanadium-containing SCR catalysts to reduce NOx and N₂O emissions due to their lower light-off temperatures. Using greater amounts of vanadium in such catalysts is desirable for improving SCR activity but lead to greater volatilisation and subsequent loss of vanadium during use, especially when arranged in the hot close-coupled position. The loss of vanadium from the close-coupled SCR catalyst causes poisoning of downstream PGM-containing oxidation catalysts thereby reducing their activity. The invention relates to an exhaust gas treatment system comprising both a close-coupled vanadium-containing SCR catalyst composition and one or more downstream PGM-containing oxidation catalyst composition(s) where the close-coupled vanadium-containing SCR catalyst composition comprises cerium in a Ce:V molar ratio of greater than 0.3. The inventors of the present invention have surprisingly found that the presence of cerium in such amounts surprisingly reduces vanadium volatilisation without a loss in performance of the SCR catalyst. The reduced volatilisation permits a greater loading of vanadium, which is desirable for improving the efficiency of the SCR catalyst. The reduced volatilisation also leads to reduced poisoning of the downstream PGM-containing oxidation catalysts so that oxidation catalysts that are smaller in size or have lower PGM loadings may be employed while still maintaining sufficient oxidation activity.

The present invention relates to an exhaust treatment system. The exhaust treatment system is a system suitable for treating an exhaust gas from a lean burn combustion engine. That is, the exhaust treatment system can be used to treat an exhaust gas derived from a combustion process in a lean burn combustion engine, which may be mobile or stationary. The exhaust treatment system comprises, in order, an intake for receiving an exhaust gas from a lean burn combustion engine, an injector for the provision of a nitrogenous reductant, a close-coupled vanadium-containing SCR catalyst composition and one or more downstream PGM-containing oxidation catalyst composition(s). In other words, the intake is upstream of the injector and the injector is upstream of the close-coupled vanadium-containing SCR catalyst composition. The close-coupled vanadium-containing SCR catalyst is upstream of the one or more PGM-containing oxidation catalyst composition(s). The exhaust treatment system may optionally comprise further components for treating exhaust gas downstream of the close-coupled vanadium-containing SCR catalyst, such as a particulate filter, which may optionally contain one or more PGMs.

The injector may be any means for injecting a nitrogenous reductant into the exhaust gas. The injector may comprise a nozzle. The injector may optionally comprise a valve. The nitrogenous reductant may comprise ammonia. The injector is arranged upstream of the close-coupled vanadium-containing SCR catalyst composition. The catalyst compositions of the present invention are for the catalytic treatment of exhaust gases from the lean burn combustion engine in order to convert or transform components of the gases before they are emitted to the atmosphere in order to meet emissions regulations.

The SCR catalyst composition stores NH₃ and selectively reduces NOx with NH₃ in the presence of oxygen. The SCR catalyst composition is arranged in the close-coupled position i.e. located near the intake for receiving exhaust gas from the engine and so is referred to as a close-coupled SCR catalyst composition. In the close-coupled position, the SCR catalyst composition is rapidly heated by exhaust gas after switch on (i.e. engine start up) thereby enabling the SCR catalyst composition to reach its light-off temperature quickly.

The closed-coupled SCR catalyst composition contains vanadium and so is referred to as a close-coupled vanadium-containing SCR catalyst composition. The presence of vanadium in an SCR catalyst composition achieves good SCR activity. The vanadium is preferably present in the close-coupled vanadium-containing SCR catalyst composition as vanadium oxides. Preferably, the close-coupled vanadium-containing SCR catalyst composition comprises at least 2 wt % vanadium, more preferably 2-6 wt % vanadium on a V₂O₅ basis (i.e. preferably the close-coupled vanadium-containing SCR catalyst composition comprises at least 2 wt %, preferably 2-6 wt % V₂O₅). Such levels are suitable for high SCR activity.

The close-coupled vanadium-containing SCR catalyst composition may be provided as an extruded porous substrate or a washcoat on a substrate, which may be porous, or may be impregnated into a substrate thereby forming a catalyst article. The substrate comprises an inlet end (upstream end) and an outlet end (downstream end) and has an axial length L.

A catalyst article is a component suitable for use in an exhaust gas system. Typically such articles are honeycomb monoliths, which may also be referred to as “bricks”. These have a high surface area configuration suitable for contacting the gas to be treated with a catalyst material to effect a transformation or conversion of components of the exhaust gas. Other forms of catalyst article are known and include plate configurations, as well as wrapped metal catalyst substrates. The catalyst articles described herein are suitable for use in all of these known forms, but it is especially preferred that they takes the form of a honeycomb monolith as these provide a good ratio of performance to volume.

The catalyst articles of the present invention are for the catalytic treatment of exhaust gases from the lean burn combustion engine in order to convert or transform components of the gases before they are emitted to the atmosphere in order to meet emissions regulations.

The close-coupled vanadium-containing SCR catalyst composition may be extruded to form an extruded porous substrate or may be applied as a washcoat to a substrate or may be impregnated into a porous substrate. The substrate may optionally be formed of a metallic or ceramic material. Therefore, the catalyst article containing the close-coupled vanadium-containing SCR catalyst composition may be an extruded, washcoated or impregnated substrate. Preferably, when the catalyst article is provided as an extruded, washcoated or impregnated porous substrate, the porous substrate is a honeycomb monolith substrate. This will typically be a flow-through type substrate, since this facilitates the entry and exit of gases from the structure. The substrate may be a filtering substrate.

When the close-coupled vanadium-containing SCR catalyst composition is disposed on a filtering substrate, this forms a selective catalytic reduction filter catalyst, which is referred to herein by the abbreviation “SCRF”.

The substrate may be cordierite-based so that it can withstand the environment, particularly the high temperatures, encountered in the close-coupled position. Other suitable substrate materials include ceramic-like materials such as α-alumina, silicon carbide, silicon nitride, zirconia, mullite, spodumene, alumina-silica-magnesia or zirconium silicate, or of porous, refractory metal. When the close-coupled vanadium-containing SCR catalyst composition is provided as a washcoat on a substrate or impregnated into a porous substrate, the substrate is preferably formed of a ceramic-like material, more preferably formed of cordierite. When the close-coupled vanadium-containing SCR catalyst composition is provided as an extruded porous substrate, the substrate may comprise titania and one or more fibers and/or binders. The close-coupled vanadium-containing SCR catalyst composition may comprise a titania-based catalyst support material.

The close-coupled vanadium-containing SCR catalyst composition comprises cerium where the molar ratio of cerium to vanadium is greater than 0.3, preferably 0.3 to 0.7, more preferably 0.4 to 0.6. Employing cerium and vanadium in such proportions reduces vanadium volatilisation without reducing the activity of the close-coupled vanadium-containing SCR catalyst composition. The reduced volatilisation permits a greater loading of vanadium, which is desirable for improving the efficiency of the SCR catalyst. The reduced volatilisation also leads to reduced poisoning of the downstream PGM-containing oxidation catalysts so that oxidation catalysts that are smaller in size or have lower PGM loadings may be employed while still maintaining sufficient oxidation activity. By way of example, the close-coupled vanadium-containing SCR catalyst composition may comprise vanadium in an amount of at 2-6 wt %, preferably 3-5 wt % on a V₂O₅ basis and cerium in an amount of 1-10 wt %, preferably 2-5 wt % on a CeO₂ basis. The close-coupled vanadium-containing SCR catalyst composition may comprise 2-6 wt %, preferably 3-5 wt % V₂O₅ and 1-10 wt %, preferably 2-5 wt % CeO₂.

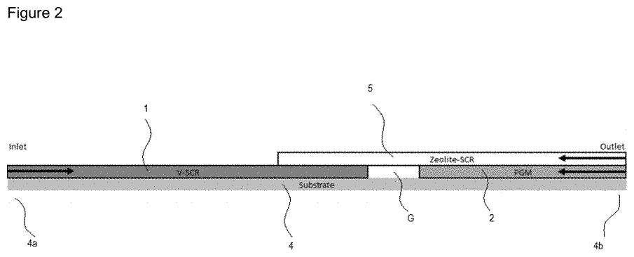

The close-coupled vanadium-containing SCR catalyst composition may additionally comprise antimony. As discussed above, antimony is sometimes used to stabilise the titania-based support material so that greater amounts of vanadium may be used in the close-coupled vanadium-containing SCR catalyst composition. However, antimony does not substantially reduce vanadium volatilisation as shown by the data in FIG. 2 of this application. Antimony may be present in an amount such that molar ratio of antimony to vanadium is greater than 0.5, preferably 0.6 to 0.9, more preferably 0.7 to 0.8. Antimony may be present as Sb₂O₅. By way of example, the close-coupled vanadium-containing SCR catalyst composition may comprise 2-6 wt % V₂O₅, 2-6 wt % CeO₂ and 3-8 wt % Sb₂O₅.

The close-coupled vanadium-containing SCR catalyst composition may additionally comprise SiO₂. SiO₂ may be present in an amount of at least 1 wt %, preferably at least 3 wt %. SiO₂ may either be doped onto the support, which may be titania, or may function as a binder. In the case where SiO₂ is used as a binder (e.g. a silica sol) it may be present up to 25 wt %. For example, when used as a binder, SiO₂ may be present in an amount of 1-20 wt %, preferably 5-20 wt %, more preferably 10-18 wt %. When used as a dopant, such as a titania dopant, SiO₂ may be present in an amount of 1-6 wt %, preferably 2-4 wt %. When used as both a dopant, such as a titania dopant, and a binder, the SiO₂ may be present in an amount of 2-26 wt %, preferably 7-24 wt %, more preferably 12-22 wt %. By way of example, the close-coupled vanadium-containing SCR catalyst composition may comprise 2-6 wt % V₂O₅, 2-6 wt % CeO₂, 3-8 wt % Sb₂O₅, 1-20 wt % SiO₂ and TiO₂ in a balance amount.

The one or more downstream platinum group metal (PGM)-containing oxidation catalyst composition(s) are arranged downstream of the close-coupled vanadium-containing SCR catalyst composition. Consequently, the exhaust gas passes through the close-coupled vanadium-containing SCR catalyst composition before passing through the one or more downstream platinum group metal (PGM)-containing oxidation catalyst composition(s). The one or more downstream PGM-containing oxidation catalyst composition(s) oxidise components of the exhaust gas before they are released to the atmosphere. In the exhaust system of the present invention, cerium present in the upstream SCR catalyst composition reduces vanadium loss therefrom. This reduces vanadium poisoning of the downstream PGM-containing oxidation composition (s) so that its oxidation activity may be substantially maintained. Consequently, the PGM-containing oxidation catalyst can be reduced in size or employ a lower loading of PGMs while still maintaining sufficient oxidation activity thereby reducing costs.

The one or more downstream PGM-containing oxidation catalyst composition(s) contain one or more platinum group metals which may be supported on a support material. The one or more platinum group metals (PGMs) present in the PGM-containing oxidation catalyst composition(s) may be selected from ruthenium, rhodium, palladium, osmium, iridium, platinum and mixtures of two or more thereof. The one or more downstream PGM-containing oxidation catalyst composition(s) may comprise at least 0.05 wt % of one or more PGMs.

The one or more downstream PGM-containing oxidation catalyst composition(s) may additionally comprise one or more Cu-zeolite(s) (i.e. a copper-containing zeolite) in addition the one or more PGMs. Additionally or alternatively, one or more Cu-zeolites may be provided in addition to the one or more downstream PGM-containing oxidation catalyst composition(s). For example, one or more Cu-zeolites may be provided between the close-coupled vanadium-containing SCR catalyst composition and the one or more PGM-containing oxidation catalyst composition(s) (i.e. downstream of the close-coupled vanadium-containing SCR catalyst composition and upstream of the one or more PGM-containing oxidation catalyst composition(s)).

Zeolites are constructed of repeating SiO₄, AlO₄, tetrahedral units linked together, for example in rings, to form frameworks having regular intra-crystalline cavities and channels of molecular dimensions. The specific arrangement of tetrahedral units (ring members) gives rise to the zeolite's framework, and by convention, each unique framework is assigned a unique three-letter code (e.g., “CHA”) by the International Zeolite Association (IZA). Zeolites may also be categorised by pore size, e.g. a maximum number of tetrahedral atoms present in a zeolite's framework. As defined herein, a “small pore” molecular sieve, such as CHA, contains a maximum ring size of eight tetrahedral atoms, whereas a “medium pore” molecular sieve, e.g. MFI, contains a maximum ring size of ten tetrahedral atoms; and a “large pore” molecular sieve, such as BEA, contains a maximum ring size of twelve tetrahedral atoms.

The Cu-zeolite may be a copper-containing large pore zeolite, medium pore zeolite or small-pore zeolite.

Most preferably, the Cu-zeolite is a small-pore zeolite. Preferably the small-pore zeolite has a framework structure selected from the group consisting of AEI, AFT, AFV, AFX, AVL, CHA, EMT, GME, KFI, LEV, LTN, and SFW, including mixtures of two or more thereof. It is particularly preferred that the Cu-zeolite has a CHA or AEI-type framework structure.

In particular, one of the downstream PGM-containing oxidation catalyst compositions may be an ammonia slip catalyst composition (ASC) (also known as an ammonia oxidation catalyst), which removes ammonia from the exhaust gas by converting it to nitrogen. This is advantageous as the ammonia oxidation catalyst composition selectively oxidises ammonia to N₂ and NOx that would otherwise slip to a less selective component further downstream, such as a DOC or CSF which would consequently generate N₂O. In the present invention, the vanadium-containing SCR catalyst of the system is in the close-coupled position with no upstream catalysts to act as heat sinks/buffers. Consequently, the close-coupled vanadium-containing SCR catalyst is most exposed to sharp temperature increases (spikes) from the engine, which can lead to ammonia desorption from storage sites of the vanadium-containing SCR catalyst and consequent ammonia slip. Therefore, employing a downstream ammonia oxidation catalyst in the exhaust system of the present invention is particularly advantageous for reducing ammonia slip and consequent generation of N₂O.

One of the downstream PGM-containing oxidation catalyst compositions may be a diesel oxidation catalyst, which oxidises one or more of NO, CO and/or hydrocarbons present in the exhaust gas. In an exemplary arrangement, the downstream PGM-containing oxidation catalyst compositions comprise an ASC and a DOC where the ASC is upstream of the DOC. In a further exemplary arrangement, the exhaust gas treatment system may further comprise a downstream SCR catalyst composition downstream of the one or more downstream PGM-containing oxidation catalyst composition(s), optionally wherein the one or more downstream PGM-containing oxidation catalyst composition(s) and the downstream SCR catalyst composition are in an SCRT® configuration. An SCRT® configuration contains, in order, a DOC, a continuously-regenerating particulate trap, a source of reductant fluid, an SCR catalyst and optionally also an ASC.

The one or more of the downstream PGM-containing oxidation catalyst composition(s) may be provided as washcoat(s) on one or more substrate(s) or impregnated into one or more porous substrate(s) or as one or more extruded porous substrate(s) to form one or more catalyst articles. In other words, the one or more of the downstream PGM-containing oxidation catalyst composition(s) may be washcoated onto or impregnated into one or more substrate(s) or extruded to form one or more extruded porous substrate(s).

The one or more downstream PGM-containing oxidation catalyst compositions may be provided on and/or in one or more substrate(s) that are separate from the substrate on and/or in which the close-coupled vanadium-containing SCR catalyst composition is provided. Such an arrangement would therefore provide a vanadium-containing SCR catalyst article upstream of one or more PGM-containing oxidation catalyst article(s). The substrate of the close-coupled vanadium-containing SCR catalyst article may be adjacent to or spaced apart from the substrate(s) of the one or more downstream PGM-containing oxidation catalyst articles. The substrate of the close-coupled vanadium-containing SCR catalyst may be referred to as a first substrate and the substrate(s) of the one or more PGM-containing oxidation catalyst article(s) may be referred to as second substrate(s).

Alternatively, one or more of the downstream PGM-containing oxidation catalyst composition(s) may be present on and/or in the same substrate as the close-coupled vanadium-containing SCR catalyst composition thereby forming a single catalyst article. Various configurations of the catalyst compositions may be employed providing that at least a portion of the close-coupled vanadium-containing SCR catalyst composition is arranged upstream of at least a portion of the one or more PGM-containing oxidation catalyst composition(s).

The area of the single catalyst article containing the close-coupled vanadium-containing SCR catalyst composition may be referred to as a first region of the single catalyst article and the area of the catalyst article containing the one or more PGM-containing oxidation catalyst composition(s) may be referred to as a second region of the single catalyst article. The first region and second region are disposed/arranged/supported on the same substrate. As discussed below, the first and/or second regions may be directly disposed/arranged/supported on the same substrate (i.e. the region is in direct contact with a surface of the substrate).

The first region may extend from the inlet end of the substrate and the second region may extend from the outlet end of the substrate.

The first region may extend along between 10% and 90% of the axial length of the substrate, preferably 25 to 85% of the axial length of the substrate and the second region may extend along between 10% and 90% of the axial length of the substrate, preferably 10 to 60% of the axial length of the substrate.

The first region containing the close-coupled vanadium-containing SCR catalyst composition and the second region containing the PGM-containing oxidation catalyst composition(s) may overlap. Preferably in the area of overlap, the close-coupled vanadium-containing SCR catalyst composition is arranged on top of the PGM-containing oxidation catalyst composition(s). The area of overlap would contain both the close-coupled vanadium-containing SCR catalyst composition and one or more PGM-containing oxidation catalyst compositions. The area of overlap may therefore form an ASC zone (ammonia slip catalyst zone) between the SCR zone and the oxidation zone.

Alternatively, the first region containing the close-coupled vanadium-containing SCR catalyst composition and the second region containing the one or more PGM-containing oxidation catalyst composition(s) may not overlap.

The first region and the second region may be impregnated areas of the substrate and/or may be washcoated layers on the substrate.

For example, the close-coupled vanadium-containing SCR catalyst composition may be provided as a washcoat on a substrate or impregnated into a substrate and the one or more downstream PGM-containing oxidation catalyst(s) may also be provided as a washcoat on or may be impregnated into the same substrate. In other words, the first region may be a washcoated layer or impregnated area containing the close-coupled vanadium-containing SCR catalyst composition and the second region may be a washcoated layer or impregnated area containing the one or more PGM-containing oxidation catalyst composition(s). In an arrangement where the first region and the second region are both formed as washcoated layers, at least a part of the washcoat containing the close-coupled vanadium-containing SCR catalyst composition is upstream of the washcoat containing the one or more downstream PGM-containing oxidation catalyst composition(s). The washcoat containing the one or more downstream PGM-containing oxidation catalyst composition(s) may be applied and dried separately from the washcoat containing the close-coupled vanadium-containing SCR catalyst composition. The washcoat containing the one or more downstream PGM-containing oxidation catalyst(s) may or may not overlap the washcoat containing the close-coupled vanadium-containing SCR catalyst composition.

The first region may be spaced apart from the second region. By “spaced apart” it is meant that the first region does not contact the second region i.e. the close-coupled vanadium-containing SCR catalyst composition does not contact the one or more downstream PGM-containing oxidation catalyst composition(s).

In an exemplary arrangement, the first region and the second region may both be directly disposed on/in the substrate (i.e. in direct contact with the substrate). The first region may be spaced apart from the second region along the length of the substrate thereby forming a gap between the first and second regions, the gap extending along the axial length of the substrate. The gap may extend along at least 10% of the length of the substrate, preferably along 20 to 50% of the axial length of the substrate.

The catalyst article may further comprise a covering region comprising an SCR catalyst composition. The covering region may be disposed over at least a part of the second region. The covering region may be a layer extending from the outlet end over at least a part of the second region. The covering region may extend over the gap formed between the first and second regions. The covering region is preferably substantially free of vanadium. The SCR catalyst composition of the covering region is therefore preferably substantially free of vanadium. The SCR catalyst composition of the covering region may comprise a zeolite. The expression “substantially free of” as used herein with reference to a material means that the material is in a minor amount, such as 5% by weight, preferably 2% by weight, more preferably 1% by weight. The expression “substantially free of embraces the expression “does not comprise”. The SCR catalyst composition of the covering region may comprise a zeolite.

In addition or as an alternative to an arrangement where the first region is spaced apart from the second region along the axial length of the substrate, the first region may be alternatively or additionally spaced apart from the second region by an intervening layer extending at least partially therebetween (i.e. the intervening layer extending between the first and second regions). In such an arrangement, the first region may be a first layer and the second region may be a second layer. The intervening layer at least partially overlaps with both the first and second regions. The intervening layer preferably overlaps with at least a downstream part of the first layer and at least an upstream part of the second layer. In other words, the intervening layer preferably overlaps with at least a part of the first layer proximal to the second layer and overlaps with at least a part of the second layer proximal to the first layer. The first layer may be directly disposed on at least a portion of the intervening layer. The intervening layer may be directly disposed on at least a portion of the second layer. The intervening layer may therefore be in direct contact with the first and second layers.

The intervening layer may comprise an SCR catalyst composition. The intervening layer is preferably substantially free of vanadium. Therefore, the SCR catalyst composition present in the intervening layer may be substantially free of vanadium. The expression “substantially free of” as used herein with reference to a material means that the material is in a minor amount, such as 5% by weight, preferably 2% by weight, more preferably 1% by weight. The expression “substantially free of” embraces the expression “does not comprise”. The SCR catalyst composition of the intervening layer may comprise a zeolite.

The intervening layer may extend from the outlet end of the substrate along 10-90% of the axial length of the substrate, preferably along 20-80% of the axial length of the substrate. Preferably, the first layer extends from the inlet end along 25-85% of the axial length of the substrate, the second layer extends from the outlet end along 10-60% of the axial length of the substrate and the third layer extends from the outlet end along 20-80% of the axial length of the substrate. Preferably, the length of the second layer extending from the outlet end is less than the length of the intervening layer also extending from the outlet end. Preferably the total of the intervening layer length and the first layer length is equal to or greater than 100% of the axial length of the substrate L.

Preferably, the total of the first layer length and the second layer length is less than 100% of the axial length of the substrate L i.e. preferably the first layer may not overlap with the second layer. However, in an arrangement where the first and second layers optionally overlap, the first and second layers may be spaced apart from each other in the area of overlap by the intervening layer. In other words, the first and second layers may be spaced apart from each other in a direction transverse to the axial length of the substrate in the area of overlap by the intervening layer. The first and second layers may overlap for 10 to 50% of the axial length of the substrate.

In an exemplary arrangement, the catalyst article may further comprise a third layer extending from the inlet end and comprising the close-coupled vanadium-containing SCR catalyst composition. The third layer may extend for less than the total axial length L of the substrate. The intervening layer may extend at least partially between the third and first layers and between the first and second layers. The third layer may be spaced apart from the second layer along the length of the substrate thereby forming a gap between the first and second regions, the gap extending along the axial length of the substrate. The gap may extend along at least 10% of the length of the substrate, preferably along 20 to 50% of the axial length of the substrate.

In arrangements comprising an intervening layer or covering layer comprising an SCR catalyst composition and extending from the outlet end, the intervening layer or covering layer together with the second region form an ASC zone. The resulting catalyst article may therefore have an ASC zone extending from the outlet end of the substrate and an SCR zone extending from the inlet end of the substrate.

In all of these arrangements, by avoiding contact between the close-coupled vanadium-containing SCR catalyst composition and the one or more PGM-containing oxidation catalyst composition(s), poisoning of the one or more PGM-containing oxidation catalyst composition(s) by the vanadium of the close-coupled vanadium-containing SCR catalyst composition may be further reduced.

In an exemplary arrangement, the close-coupled vanadium-containing SCR catalyst composition may be extruded to form an extruded porous substrate and the one or more PGM-containing oxidation catalyst compositions(s) may be washcoated onto or impregnated into a downstream part of the extruded porous substrate containing the close-coupled vanadium-containing SCR catalyst composition.

The present invention also relates to a combustion and exhaust treatment system comprising a lean burn combustion engine and the exhaust gas treatment system described above. The exhaust gas treatment system has an intake that receives the exhaust gas from the lean burn combustion engine. The lean burn combustion engine may be mobile or stationary. In a lean burn combustion engine, combustion occurs at an air/fuel ratio higher than the stoichiometric air/fuel ratio. The lean burn combustion engine may be an internal combustion engine, such as diesel engine, a lean burn gasoline engine, a H₂-fueled internal combustion engine, or a hybrid of two of these.

According to a further aspect there is provided a method for the treatment of an exhaust gas, the method comprising treating an exhaust gas in the exhaust gas treatment system described above. Accordingly, all features described for the system apply equally to the method aspect. The method typically comprises contacting the close-coupled vanadium-containing SCR catalyst composition and then downstream PGM-containing oxidation catalyst composition(s) with the exhaust gas received from the lean burn combustion engine.

According to a further aspect, there is provided the use of cerium to reduce vanadium-loss from a close-couple vanadium-containing SCR catalyst composition, wherein the close-coupled vanadium-containing SCR catalyst composition comprises cerium in a Ce:V molar ratio of greater than 0.3.

Preferably the use described in this aspect can be applied to the method and system described herein. Accordingly, all features described as preferably for the system and method apply equally to the use aspect.

According to a further aspect, there is provided an exhaust gas treatment system comprising, in order:
an intake for receiving an exhaust gas from a lean burn combustion engine;
an injector for the provision of a nitrogenous reductant;
a close-coupled vanadium-containing SCR catalyst composition;
one or more downstream catalyst compositions comprising a copper-containing zeolite,
wherein the close-coupled vanadium-containing SCR catalyst composition comprises cerium in a Ce:V molar ratio of greater than 0.3.

The description of the exhaust gas system above equally apply to this aspect which requires one or more downstream catalyst composition(s) comprising a copper-containing zeolite. For example, the description of the close-coupled vanadium-containing SCR catalyst composition above equally applies to this aspect. The description of the configuration of the one or more downstream PGM-containing oxidation catalyst composition(s) above equally applies to the configuration of the one or more downstream catalyst composition(s) comprising a copper-containing zeolite as required by this aspect.

In the aspects described above, it is noted that the one or more downstream PGM-containing oxidation catalyst composition(s) may additionally comprise a copper-containing zeolite (Cu-zeolite). The description of the copper-containing zeolite that may be present in the downstream PGM-containing oxidation catalyst composition(s) in the aspect described above equally applies to the copper-containing zeolite of this aspect which may be present without the downstream PGM-containing oxidation catalyst composition(s).

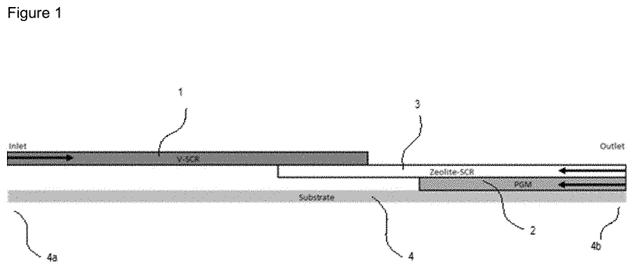

FIG. 1 shows a schematic diagram of a first exemplary catalyst article of the present invention having a substrate on which a first region (1), a second region (2) and an intervening layer (3) are disposed. The substrate has an inlet (upstream) end 4a and an outlet (downstream) end 4b and an axial length L. The arrows of FIG. 1 indicate from which end of the substrate each region/layer has been applied (the first region (1) being applied from the inlet end 4a, the second region (2) and intervening layer (3) being applied from the outlet end 4b). During use, exhaust gas to be treated flows into the catalyst article via the inlet end 4a and out of the catalyst article through the outlet end 4b. The first region (1) is a first layer and contains the close-coupled vanadium-containing SCR catalyst composition. The first layer extends from the inlet end 4a for less than the total axial length of the substrate L. The second region (2) is a second layer and contains the PGM-containing oxidation catalyst composition(s). The second layer extends from the outlet end 4b for less than the total axial length of the substrate L. The second layer (2) is directly disposed on the substrate (4). The first and second layers (1), (2) do not overlap. The intervening layer (3) is disposed on the second layer (2) and extends from the outlet end 4b for less than the total axial length of the substrate (L). The intervening layer has a greater length than the second layer. The intervening layer (3) extends at least partially between the first layer (1) and the second layer (2). The intervening layer overlaps with the downstream part of the first layer (1) and the whole of the second layer (2). An upstream part of the first layer (1) is in directly disposed on the substrate and a downstream part of the first layer (1) is directly disposed on an upstream part of the intervening layer (3). The intervening layer (3) contains an SCR catalyst composition and is substantially free of vanadium. The SCR catalyst composition of the intervening layer (3) comprises a zeolite. The presence of the intervening layer (3) increases the size of the gap along the length of the substrate (4) between the part of the first layer (1) in direct contact with the substrate and the second layer (2).

FIG. 2 shows a schematic diagram of a second exemplary catalyst article of the present invention having a substrate on which a first region (1), a second region (2) and a covering later (5) are disposed on a substrate (4). The substrate has an inlet (upstream) end 4a and an outlet (downstream) end 4b and an axial length L. The arrows of FIG. 2 indicate from which end of the substrate each region/layer has been applied (the first region (1) being applied from the inlet end 4a, the second region (2) and covering layer (5) being applied from the outlet end 4b). During use, exhaust gas to be treated flows into the catalyst article via the inlet end 4a and out of the catalyst article through the outlet end 4b. The first region (1) is a first layer and contains the vanadium-containing SCR catalyst composition. The first layer (1) extends from the inlet end 4a for less than the total axial length of the substrate L. The second region (2) is a second layer and contains the PGM-containing oxidation catalyst composition(s). The second layer (2) extends from the outlet end 4b for less than the total axial length of the substrate L. The first layer (1) and the second layer (2) are directly disposed on (i.e. in direct contact with) the substrate (4). The first and second layers (1), (2) do not overlap i.e. the total length of the first and second layers is less than 100% of the total axial length L of the substrate. A gap (G) is therefore formed along the axial length of the substrate L between the first and second layers. The gap extends between the downstream end of the first layer (1) and the upstream end of the second layer (2). A covering layer (5) extends from the outlet end for less than the total axial length L of the substrate (4). The covering layer (5) is directly disposed on the first layer (1) and the second layer (2) and covers the gap (G). The covering layer (5) has a greater length than the second layer (2). The covering layer (5) overlaps with the first layer (1) and the second layer (2). More specifically, the covering layer (5) overlaps with a downstream part of the first layer (1) and the whole of the second layer (2). The covering layer (5) contains an SCR catalyst composition and is substantially free of vanadium. The SCR catalyst composition of the covering layer (5) comprises a zeolite. In this arrangement, contact between the first and second layers (1, 2) is avoided thereby reducing poisoning of the PGM-containing oxidation catalyst composition of the second layer (2). An ASC zone is provided extending from the outlet without poisoning of the PGM-containing oxidation catalyst composition.

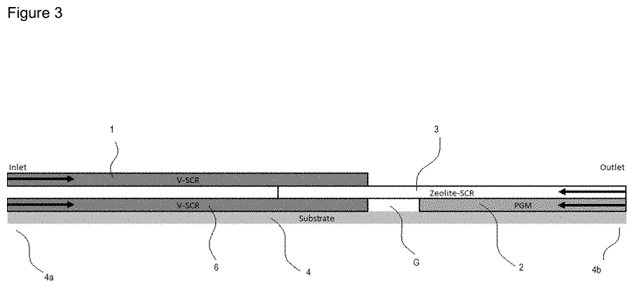

FIG. 3 shows a schematic diagram of a third exemplary catalyst article of the present invention having a substrate (4) on which a first region (1), a second region (2), an intervening layer (3) and a third layer (6) are disposed. The substrate has an inlet (upstream) end 4a and an outlet (downstream) end 4b and an axial length L. The arrows of FIG. 1 indicate from which end of the substrate each region/layer has been applied (the first region (1) and the third layer (6) being applied from the inlet end 4a, the second region (2) and intervening layer (3) being applied from the outlet end 4b). During use, exhaust gas to be treated flows into the catalyst article via the inlet end 4a and out of the catalyst article through the outlet end 4b. The first region (1) is a first layer and contains the vanadium-containing SCR catalyst composition. The first layer (1) extends from the inlet end 4a for less than the total axial length of the substrate L. The second region (2) is a second layer and contains the PGM-containing oxidation catalyst composition(s). The second layer (2) extends from the outlet end 4b for less than the total axial length of the substrate L. The second layer (2) is directly disposed on the substrate (4). The first and second layers (1), (2) do not overlap. An intervening layer (3) is disposed on the second layer (2) and extends from the outlet end 4b for less than the total axial length of the substrate (L). The intervening layer (3) has a greater length than the second layer (2). The intervening layer (3) extends at least partially between the first layer (1) and the second layer (2). The intervening layer (3) overlaps with the downstream part of the first layer (1) and the whole of the second layer (2). An upstream part of the first layer (1) is directly disposed on the third layer (6) and a downstream part of the first layer (1) is directly disposed on an upstream part of the intervening layer (3). The intervening layer (3) contains an SCR catalyst composition and is substantially free of vanadium. The SCR catalyst composition of the intervening layer (3) comprises a zeolite. The third layer (6) extends from the inlet end (4a) for less than the total axial length of the substrate (4) and is directly disposed on the substrate (4). Similarly to the first layer (1), the third layer (6) also contains the close-coupled vanadium-containing SCR catalyst composition. The intervening layer (3) at least partially extends between the first and third layers. The third layer (6) and the first layer (1) have the same length. Therefore, the third and second layers (6, 2) do not overlap.

### EXAMPLES

The invention will now be described further in relation to the following non-limiting examples.

### Examples 1 to 6

Examples 1 to 4 and 6 are comparative examples. Example 5 is in accordance with the invention.

The catalyst of Example 1 is a washcoated catalyst having 130 g/ft³ vanadium, 3.0 g/in³ of TiO₂ (and 1.0 g/in³ SiO₂.

The vanadium was present in Example 1 as vanadium oxides supported on titania. The vanadium loading in the catalyst of Example 1 as V₂O₅ is 3.3 wt %.

The catalyst was prepared by forming an aqueous slurry comprising vanadyl oxalate, a high surface area titania powder and an aqueous dispersion of colloidal silica. Specifically, the high surface area titania powder employed was DT-51d obtained from Tronox® and the aqueous dispersion of colloidal silica employed was Ludox® AS-40 from Grace. The aqueous slurry had a final pH of 5-8 and was deposited on a substrate, which was a cordierite flowthrough monolith, by a suction process, followed by drying and calcination. The catalyst was dried at 100° C. for approximately 15 minutes, and subsequently calcined at 500° C. for approximately 10 minutes.

The catalysts of Examples 2 to 6 are washcoated catalysts also having 130 g/ft³ vanadium, 3.0 g/in³ of TiO₂ and 1.0 g/in³ SiO₂. Each catalyst of Examples 2 to 6 differ from the catalyst of Example 1, as the catalysts of Examples 2 to 6 also contain an additional metal present as an oxide, the metal referred to herein as the “added metal”, where the molar ratio of the added metal to vanadium is 0.4. The added metal and relevant amount present in the catalysts of Examples 2 to 6 is set out in Table 1 below.

The vanadium was present in Examples 2 to 6 as vanadium oxides supported on titania. The vanadium loading in the catalysts of Examples 2 to 6 as V₂O₅ is 3.2 wt %.

Similarly to Example 1, the catalysts of Example 2 to 6 were prepared by forming an aqueous slurry comprising vanadyl oxalate, a high surface area titania powder, an aqueous dispersion of colloidal silica and a precursor for the added metal, which is set out in the table below. Specifically, the high surface area titania powder employed was DT-51d obtained from Tronox® and the aqueous dispersion of colloidal silica employed was Ludox® AS-40 from Grace. The aqueous slurry had a final pH of 5-8 and was deposited on a catalyst monolith by a suction process, followed by drying and calcination. The catalyst was were dried at 100° C. for approximately 15 minutes, and subsequently calcined at 500° C. for approximately 10 minutes.

TABLE 1

| | | Amount of added | |
|---|---|---|---|
| | Added | metal (g/ft³) (Amount | |
| Example | Metal | of added metal | |
| No. | Present | oxide (wt %)) | Preparation |
| 2 | W | 188 g/ft³ (3.2 wt % as | Washcoated with a slurry |
| | | WO₃) | containing vanadyl oxalate, |
| | | | titania powder, colloidal |
| | | | silica and ammonium |
| | | | metatungstate |
| 3 | Sb | 124 g/ft³ (1.9 wt % as | Washcoated with a slurry |
| | | Sb₂O₃) | containing vanadyl oxalate, |
| | | | titania powder, colloidal |
| | | | silica and antimony acetate |
| 4 | Nb | 95 g/ft³ (1.9 wt % as | Washcoated with a slurry |
| | | Nb₂O₅) | containing vanadyl oxalate, |
| | | | titania powder, colloidal |
| | | | silica and ammonium |
| | | | niobium oxalate |
| 5 | Ce | 143 g/ft³ (2.4 wt % as | Washcoated with a slurry |
| | | CeO₂) | containing vanadyl oxalate, |
| | | | titania powder, colloidal |
| | | | silica and cerium acetate |
| 6 | Er | 171 g/ft³ (2.7 wt % as | Washcoated with a slurry |
| | | Er₂O₃) | containing vanadyl oxalate, |
| | | | titania powder, colloidal |
| | | | silica and erbium acetate |

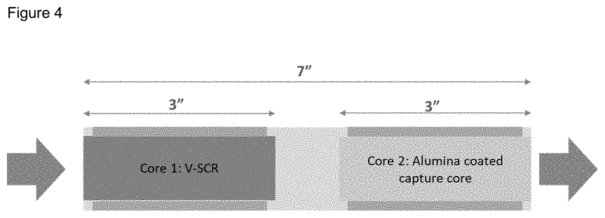

Each of the catalysts of Examples 1 to 6 were formed as washcoats on substrate cores (bricks) formed of cordierite (cordierite flow through monoliths) having a size of 1″×3″ 300/5 and were each loaded into a respective holder as shown in FIG. 4. The catalysts were aged in parallel on engine behind a DOC+CSF with a core holder inlet temperature of 560° C. (+1-10° C.) for 100 hrs, at ^{˜}26K SV and with urea dosed upstream of the holder at ANR1.05. H₂O level during ageing was ^{˜}9-10%. As shown in FIG. 4, an alumina coated substrate core (labelled as core 2: alumina coated capture core in FIG. 4) was positioned downstream (i.e. behind) each of the catalysts of Examples 1 to 6 (labelled as core 1: V-SCR in FIG. 4) within the holder to capture volatilised vanadium. The arrows in FIG. 4 indicate the direction of exhaust gas therethrough.

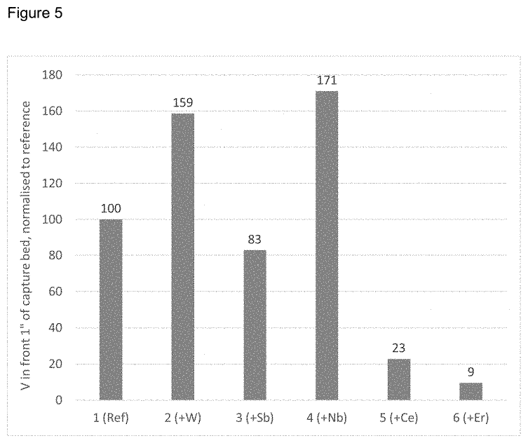

The first/front 1″ of each alumina coated substrate core was analysed by XRF for vanadium and titania content to determine the vanadium loss from the vanadium-containing SCR catalysts of Examples 1 to 6 upstream of the respective alumina coated substrate core. Results were corrected for any washcoat loss by comparing the measured titania against baseline level. Baseline vanadium content in each alumina coated substrate core brick was also subtracted, which was approximately 49 ppm from cordierite. The results are shown in the graph of FIG. 5 and are also provided in Table 2 below.

TABLE 2

| | Vanadium captured in front 1″ of respective |
|---|---|
| | alumina coated substrate core (% relative to |
| Example | amount of vanadium captured for Example 1) |
| 1 | 100 |
| 2 | 159 |
| 3 | 83 |
| 4 | 171 |
| 5 | 23 |
| 6 | 9 |

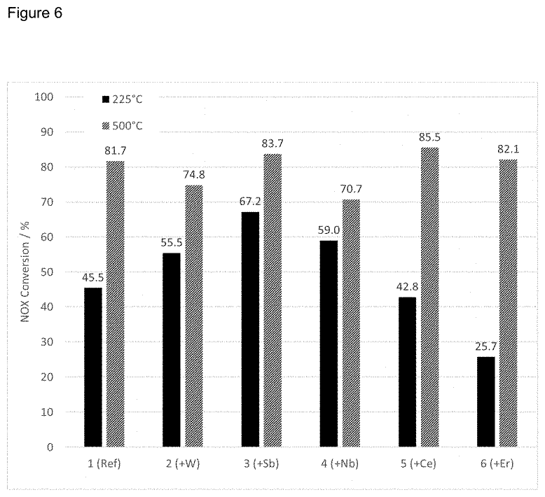

The fresh NOx conversion activity at both 225 and 500° C. was measured for Examples 1 to 6 by flowing a synthetic gas mixture through the catalysts of Examples 1 to 6 on a laboratory flowthrough reactor. The synthetic gas mixture had a 60K SV and contained NO 500 ppm, NH₃ 525 ppm, CO₂ 8%, O₂ 10%, CO 0.035%, H₂O 5% and N₂ balance. The results shown in the graph of FIG. 6. For each example, the NOx conversion activity was lower at 225° C. than 500° C.

As can be seen from the graph of FIG. 5, the vanadium-containing SCR catalyst employing cerium demonstrated significantly less vanadium loss compared to a vanadium-containing SCR catalyst without an added metal (Example 1) and compared to vanadium-containing SCR catalysts employing other metals, such as W, Sb or Nb (Examples 2, 3 and 4). Indeed, it can be seen than the presence of antimony provides substantially no effect on vanadium loss (Example 4) and the presence of W or Nb actually increases vanadium loss compared to a vanadium-containing SCR catalyst without an added metal (Example 1).

FIG. 5 shows that the vanadium-containing catalyst containing erbium (Example 6) achieved slightly less vanadium loss than the vanadium-containing catalyst containing cerium (Example 5). However, as shown in the graph of FIG. 5, the presence of erbium significantly impacts low temperature NOx conversion. Indeed, the NOx conversion at 225° C. was reduced from 45% to 25% due to the presence of erbium as shown by comparing the NOx conversion achieved for Example 1 with that for Example 6. Therefore, although the presence of erbium in the SCR catalyst reduced vanadium loss, it also reduced the low temperature NOx conversion activity. In contrast, the vanadium-containing catalyst employing cerium demonstrated substantially the same NOx conversion at 225° C. and slightly higher NOx conversion at 500° C. compared to the vanadium-containing catalyst without an added metal. Accordingly, the presence of cerium in the vanadium-containing catalyst reduced vanadium loss from the SCR catalyst without impacting its NOx conversion activity.

### Examples 7 to 18

Examples 8 to 14 and 16 to 18 are in accordance with the invention. Examples 7 and 15 are comparative examples.

Examples 7 to 14 were formed as washcoats on substrates. Examples 15 to 18 were formed as extrudates. The compositions of Examples 7 to 14 are set out in Table 3 provided below. The compositions of Examples 15 to 18 are set out in Table 4 provided below.

The washcoated vanadium-containing catalysts (Examples 7 to 14) contained V₂O₅ in an amount of 4.5 wt %, Sb₂O₅ in an amount of 5.6 wt %, SiO₂ in an amount as indicated in Table 3 below, optionally CeO₂ as indicated in Table 3 below and balance TiO₂. As shown in Table 3 below, the washcoated vanadium-containing catalyst free of ceria (Example 7) contained 18.73% SiO₂. For the washcoated vanadium-containing catalysts also containing ceria (Examples 8 to 14), the SiO₂ content was reduced to compensate for the added CeO², therefore maintaining the total washcoat loading and V & Sb content to be constant for all of Examples 7 to 14.

TABLE 3

| | Composition | | |
|---|---|---|---|
| | CeO₂ | Ce:V (molar | |
| Example No. | (wt %) | ratio) | SiO₂ (wt %) |
| Example 7 | 0 | 0 | 18.7 |
| Example 8 | 1.5 | 0.18 | 17.2 |
| Example 9 | 3.2 | 0.38 | 15.6 |
| Example 10 | 4.7 | 0.55 | 14.1 |
| Example 11 | 6.2 | 0.73 | 12.6 |
| Example 12 | 7.7 | 0.90 | 11.1 |
| Example 13 | 9.3 | 1.09 | 9.4 |
| Example 14 | 14.0 | 1.64 | 4.7 |

Each of the washcoated catalysts (Examples 7 to 14) were prepared by forming an aqueous slurry comprising vanadyl oxalate, a high surface area titania powder, an aqueous dispersion of colloidal ceria, and an aqueous dispersion of colloidal silica. Specifically, the high surface area titania powder employed was DT-51d obtained from Tronox® and the aqueous dispersion of colloidal silica employed was Ludox® AS-40 from Grace. The aqueous dispersion of colloidal ceria employed was JMA702 from Solvay. The aqueous slurry had a final pH of 5-8 and was deposited on a catalyst monolith by a suction process, followed by drying and calcination. The catalysts were dried at 100° C. for approximately 15 minutes, and subsequently calcined at 500° C. for approximately 10 minutes.

The extruded vanadium-containing catalyst contained V₂O₅ in an amount of 4.5 wt %, antimony pentoxide in an amount of 6.7 wt %, 14.5 wt % of binders and balance Silica containing Titania.

Each of the extruded catalysts (Examples 15 to 18) were prepared by mixing a commercially available Silica containing Titania (anatase at a nominal SiO₂ content of 3.5 wt %) with ammonium meta vanadate to reach the desired V₂O₅ equivalent. CeO₂ was added as disclosed in Table 4, reducing the Titania Silica content accordingly. 8 wt % glass fibres and 6.4 wt % of a low alkaline containing clay were added as binders/strength improving components. Approximately 1-2 wt % cellulose, 1-2 wt % poly ethylene oxide and ammonia solution were blended in a next step to prepare a well plasticised shapable paste with a pH 5-7 by using a kneader. The paste was extruded into a flow-through honeycomb body with continuous channels and a circular cross section exhibiting a cell density of 400 cpsi. Subsequently the catalyst body was freeze dried for 1 hour at 2 mbar according to the method described in WO2009/080155, which is incorporated herein by reference, and calcined at a temperature of 580° C. to form a solid catalyst body. The general method for the preparation of these catalysts is described in WO002013017873A1, which is incorporated herein by reference.

TABLE 4

Composition

| Example No. | CeO₂ (wt %) | Ce:V molar ratio |
|---|---|---|
| 15 | 0 | 0 |
| 16 | 1 | 0.12 |
| 17 | 2 | 0.23 |
| 18 | 6 | 0.70 |

Each of the catalysts of Examples 7 to 14 were provided as washcoats on substrate cores (bricks) formed of cordierite having a size of 1″×3″ 300/5 and each of the catalysts of Examples 15 to 18 were provided as extrudates formed as cores/bricks having a size of 1″×3″ 400/11. Each of the cores/bricks of Examples 7 to 18 were loaded into a respective holder as shown in FIG. 4. The catalysts were aged in parallel on engine behind a DOC+CSF with a core holder inlet temperature of 560° C. (+/−10° C.) for 100 hrs, at ^{˜}26K SV and with urea dosed upstream of the holder at ANR1.05. H₂O level during ageing was ^{˜}9-10%. As shown in FIG. 4, an alumina coated substrate core was positioned downstream (i.e. behind) each of the catalysts of Examples 7 to 14 (a), (b) within the holder to capture volatilised vanadium.

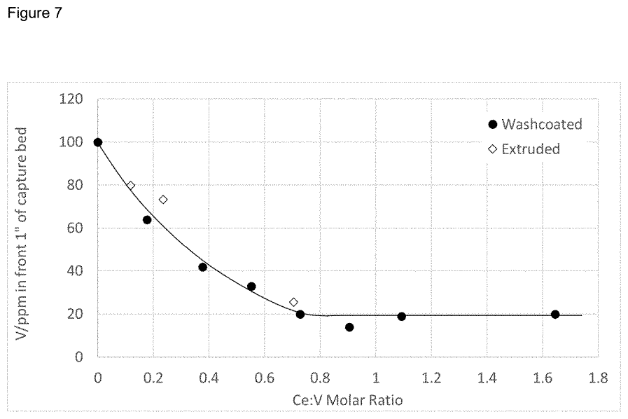

The first/front 1″ of each alumina coated substrate core was analysed by XRF for vanadium and titania content to determine the vanadium loss from the vanadium-containing SCR catalysts of Examples 7 to 18 upstream of the respective alumina coated substrate core. Results were corrected for any washcoat loss by comparing the measured titania against baseline level. Baseline vanadium content in each alumina coated substrate core brick was also subtracted, which was approximately 49 ppm from cordierite. The results are shown in the graph of FIG. 7. FIG. 7 is therefore a graph demonstrating the impact of cerium loading on loss of vanadium from a washcoated vanadium-containing SCR catalyst and an extruded vanadium-containing SCR catalyst.

As shown by the graph of FIG. 7, the presence of ceria in the vanadium-containing SCR catalyst demonstrates reduced vanadium loss at all loadings of ceria tested (i.e. 1 wt % to 14 wt %) compared to a vanadium-containing SCR catalyst without ceria. Ceria loadings equating to molar ratios of cerium:vanadium of 0.3 or more leads to an approximate reduction by 50% of the vanadium loss. As shown in FIG. 6, no further reduction in vanadium loss is achieved for molar ratios of Ce:V of greater than 0.7.

### Examples 19 to 27

The catalysts of Examples 19 to 27 are washcoated catalysts having 3.81 g/in³ of TiO₂, 1.0 g/in³ SiO₂, vanadium in amounts set out in Table 5 and an additional metal as shown in Table 5 referred to as “added metal” in an amount of 389 g/ft³. Each catalyst of Examples 19 to 21 contain cerium in an amount of 389 g/ft³ but differ in the amount of vanadium present as shown in Table 5 below. For the catalysts of Examples 19 to 21, the molar ratio of cerium:vanadium spanned 0.55 to 0.85. Each catalyst of Examples 22 to 24 contain tungsten in an amount of 389 g/ft³ but differ in the amount of vanadium present as shown in Table 5 below. Examples 25 to 27 contain niobium in an amount of 389 g/ft³ but differ in the amount of vanadium present as shown in Table 5 below.

The vanadium was present in Examples 19 to 27 as vanadium oxides supported on titania.

The catalysts of Example 19 to 27 were prepared by forming an aqueous slurry comprising vanadyl oxalate, a high surface area titania powder, an aqueous dispersion of colloidal silica and a precursor for the added metal, which is set out in Table 5 below. Specifically, the high surface area titania powder employed was DT-51d obtained from Tronox® and the aqueous dispersion of colloidal silica employed was Ludox® AS-40 from Grace. The aqueous slurry had a final pH of 5-8 and was deposited on a catalyst monolith by a suction process, followed by drying and calcination. The catalyst was were dried at 100° C. for approximately 15 minutes, and subsequently calcined at 500° C. for approximately 10 minutes.

TABLE 5

| | | | Amount of | |
|---|---|---|---|---|
| | | | Vanadium | |
| | Added | Amount of added | present in | |
| Example | Metal | metal present in | catalyst | |
| No. | Present | catalyst (g/ft³) | (g/ft³) | Preparation |
| 19 | Ce | 389 | 135 | Washcoated with a slurry |
| | | | | containing vanadyl oxalate, |
| | | | | titania powder, colloidal silica |
| | | | | and cerium acetate |
| 20 | Ce | 389 | 160 | Washcoated with a slurry |
| | | | | containing vanadyl oxalate, |
| | | | | titania powder, colloidal silica |
| | | | | and cerium acetate |
| 21 | Ce | 389 | 210 | Washcoated with a slurry |
| | | | | containing vanadyl oxalate, |
| | | | | titania powder, colloidal silica |
| | | | | and cerium acetate |
| 22 | W | 389 | 136 | Washcoated with a slurry |
| | | | | containing vanadyl oxalate, |
| | | | | titania powder, colloidal silica |
| | | | | and ammonium metatungstate |
| 23 | W | 389 | 160 | Washcoated with a slurry |
| | | | | containing vanadyl oxalate, |
| | | | | titania powder, colloidal silica |
| | | | | and ammonium metatungstate |
| 24 | W | 389 | 210 | Washcoated with a slurry |
| | | | | containing vanadyl oxalate, |
| | | | | titania powder, colloidal silica |
| | | | | and ammonium metatungstate |
| 25 | Nb | 389 | 135 | Washcoated with a slurry |
| | | | | containing vanadyl oxalate, |
| | | | | titania powder, colloidal silica |
| | | | | and ammonium niobium oxalate |
| 26 | Nb | 389 | 160 | Washcoated with a slurry |
| | | | | containing vanadyl oxalate, |
| | | | | titania powder, colloidal silica |
| | | | | and ammonium niobium oxalate |
| 27 | Nb | 389 | 210 | Washcoated with a slurry |
| | | | | containing vanadyl oxalate, |
| | | | | titania powder, colloidal silica |
| | | | | and ammonium niobium oxalate |

Each of the catalysts of Examples 19 to 27 were formed as washcoats on substrate cores (bricks) formed of cordierite (cordierite flowthrough monliths) having a size of 1″×3″ 300/5 and were each loaded into a respective holder as shown in FIG. 4. The catalysts were aged in parallel on engine behind a DOC+CSF with a core holder inlet temperature of 560° C. (+/−10° C.) for 100 hrs, at ^{˜}26K SV and with urea dosed upstream of the holder at ANR1.05. H₂O level during ageing was ^{˜}9-10%. As shown in FIG. 4, an alumina coated substrate core was positioned downstream (i.e. behind) each of the catalysts of Examples 19 to 27 within the holder to capture volatilised vanadium.

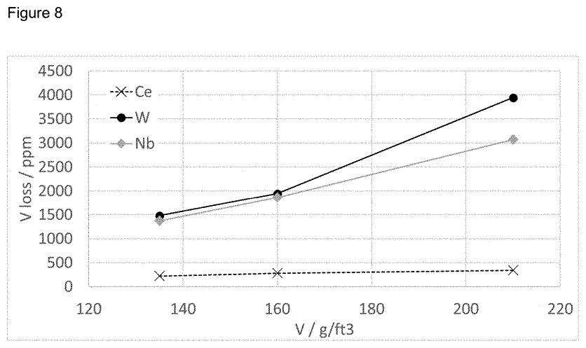

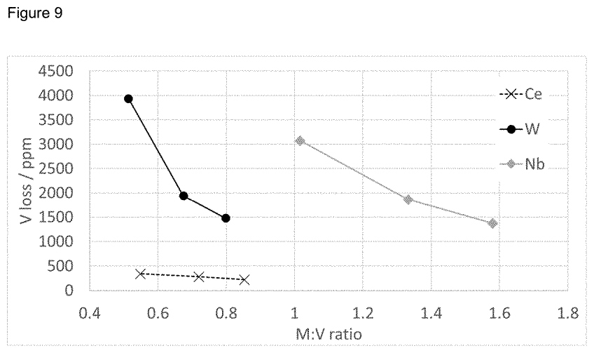

The first/front 1″ of each alumina coated substrate core was analysed by XRF for vanadium and titania content to determine the vanadium loss from the vanadium-containing SCR catalysts of Examples 19 to 27 upstream of the respective alumina coated substrate core. Results were corrected for any washcoat loss by comparing the measured titania against baseline level. Baseline vanadium content in each alumina coated substrate core brick was also subtracted, which was approximately 49 ppm from cordierite. The results are shown in the graph of FIGS. 8 and 9. FIG. 8 is a graph of vanadium loading of the catalysts of Examples 19 to 27 against vanadium loss therefrom whereas FIG. 9 is a graph of the molar ratio of the added metal:vanadium of the catalysts of Examples 19 to 27 against vanadium loss therefrom. The data shown by crosses joined by a dashed line are in respect of Examples 19 to 21, the data shown by black circles joined by a solid line are in respect of Examples 22 to 24 and the data shown by grey squares joined by a solid line are in respect of Examples 25 to 27.

As shown in FIGS. 8 and 9, the presence of cerium significantly reduced volatility at all three loadings of vanadium tested to approximately 250 ppm, which equate to molar ratios of cerium:vanadium of approximately 0.55 to 0.85. In contrast, the presence of niobium or tungsten in the same amount of 389 g/ft³ demonstrated high vanadium loss that increased with vanadium loading (vanadium losses of 1400 to 3900 ppm for Examples 22 to 27).

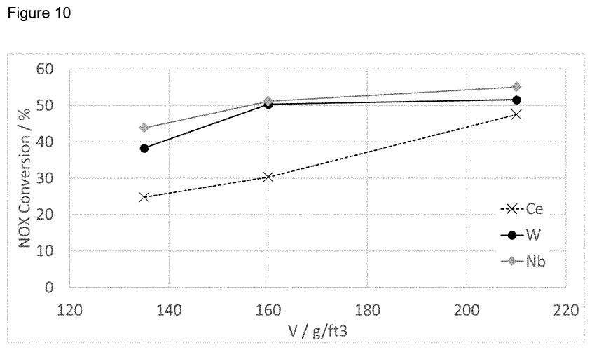

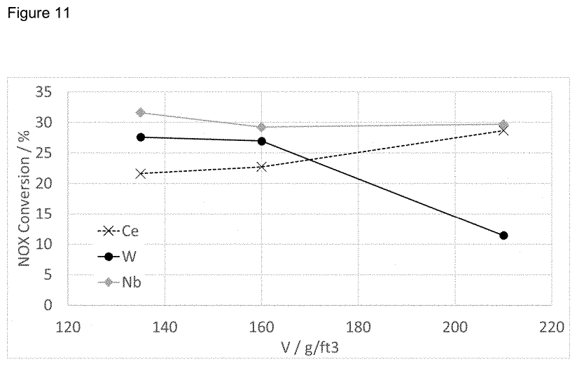

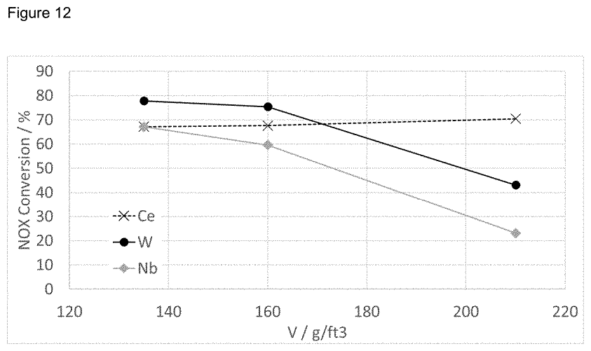

The fresh NOx conversion activity at both 225 and 500° C. and the aged NOx conversion activity at 225° C. was measured for Examples 19 to 27 by flowing a synthetic gas mixture through the catalysts of Examples 19 to 27 on a laboratory flowthrough reactor. The synthetic gas mixture had a 60K SV and contained NO 500 ppm, NH₃ 525 ppm, CO₂ 8%, O₂ 10%, CO 0.035%, H₂O 5% and N² balance. The results are shown in the graphs of FIG. 10 (fresh NOx activity at 225° C.), FIG. 11 (aged NOx activity at 225° C.) and FIG. 12 (fresh NOx activity at 500° C.). The data shown by crosses joined by a dashed line are in respect of Examples 19 to 21, the data shown by black circles joined by a solid line are in respect of Examples 22 to 24 and the data shown by grey squares joined by a solid line are in respect of Examples 25 to 27.

As shown in FIGS. 10, 11 and 12 less NOx conversion was demonstrated for the fresh and aged cerium-containing examples having a lower loading of vanadium (Examples 19 and 20) compared to the tungsten or niobium-containing examples having the same, lower loading of vanadium (Examples 21, 22, 24 and 25). However, the presence of cerium enables the vanadium loading to be increased to consequently increase NOx conversion at 225° C. and at 500° C. as demonstrated by Example 21. As demonstrated by the data shown in FIGS. 8 and 9, this increase in NOx conversion is achieved without compromising vanadium volatility. Therefore, FIGS. 8 and 9 together with FIGS. 10, 11 and 12 demonstrate that the presence of cerium in the vanadium-containing SCR catalyst reduced vanadium loss therefrom even at high vanadium loadings without impacting its fresh NOx conversion activity at both 225 and 500° C. and aged NOx conversion activity at 225° C.

As used herein, the singular form of “a”, “an” and “the” include plural references unless the context clearly dictates otherwise. The use of the term “comprising” is intended to be interpreted as including such features but not excluding other features and is also intended to include the option of the features necessarily being limited to those described. In other words, the term also includes the limitations of “consisting essentially of” (intended to mean that specific further components can be present provided they do not materially affect the essential characteristic of the described feature) and “consisting of” (intended to mean that no other feature may be included such that if the components were expressed as percentages by their proportions, these would add up to 100%, whilst accounting for any unavoidable impurities), unless the context clearly dictates otherwise.

The term “region” as used herein refers to an area of washcoat or impregnated catalyst composition on a substrate. A “region” can, for example, be disposed or supported on a substrate as a “layer” or a “zone”. The area or arrangement of a catalyst composition on a substrate is generally controlled during the process of applying the washcoat to the substrate or impregnating the catalyst composition into the substrate. The “region” typically has distinct boundaries or edges (i.e. it is possible to distinguish one region from another region using conventional analytical techniques).

The term “washcoat” is well known in the art and refers to an adherent coating that is applied to a substrate usually during production of a catalyst.

Typically, the “region” has a substantially uniform length. The reference to a “substantially uniform length” in this context refers to a length that does not deviate (e.g. the difference between the maximum and minimum length) by more than 10%, preferably does not deviate by more than 5%, more preferably does not deviate by more than 1%, from its mean value.

It is preferable that each “region” has a substantially uniform composition (i.e. there is no substantial difference in the composition of the washcoat when comparing one part of the region with another part of that region). Substantially uniform composition in this context refers to a material (e.g. region) where the difference in composition when comparing one part of the region with another part of the region is 10% or less, usually 5% or less, and most commonly 2.5% or less.

The total length of a substrate is the distance between its inlet end and its outlet end (e.g. the opposing ends of the substrate).

The expression “substantially free of” as used herein with reference to a material, typically in the context of the content of a region, a layer or a zone, means that the material in a minor amount, such as 5% by weight, preferably 2% by weight, more preferably ≤1% by weight. The expression “substantially free of” embraces the expression “does not comprise”.

It will be understood that, although the terms “first”, “second”, etc. may be used herein to describe various elements, layers and/or portions, the elements, layers and/or portions should not be limited by these terms. These terms are only used to distinguish one element, layer or portion from another, or a further, element, layer or portion. Spatially relative terms, such as “under”, “below”, “beneath”, “lower”, “over”, “above”, “upper” and the like, may be used herein for ease of description to describe one element or feature's relationship to another element(s) or feature(s). It will be understood that the spatially relative terms are intended to encompass different orientations of the system in use or operation in addition to the orientation depicted in the figures. For example, if a catalyst article or system as described herein is turned over, elements described as “under” or “below” other elements or features would then be oriented “over” or “above” the other elements or features. Thus, the example term “under” can encompass both an orientation of over and under. The catalyst article or system may be otherwise oriented and the spatially relative descriptors used herein interpreted accordingly.

The foregoing detailed description has been provided by way of explanation and illustration, and is not intended to limit the scope of the appended claims. Many variations in the presently preferred embodiments illustrated herein will be apparent to one of ordinary skill in the art, and remain within the scope of the appended claims and their equivalents.

1. An exhaust gas treatment system comprising, in order:
an intake for receiving an exhaust gas from a lean burn combustion engine;
an injector for the provision of a nitrogenous reductant;
a close-coupled vanadium-containing SCR catalyst composition;
one or more downstream PGM-containing oxidation catalyst compositions,
wherein the close-coupled vanadium-containing SCR catalyst composition comprises cerium in a Ce:V molar ratio of greater than 0.3.

2. The exhaust gas treatment system of claim 1, wherein vanadium is present in the close-coupled vanadium-containing SCR catalyst composition in an amount of at least 2 wt % on a V₂O₅ basis.

3. The exhaust gas treatment system of claim 1, wherein the close-coupled vanadium-containing SCR catalyst composition further comprises antimony in an Sb:V molar ratio of greater than 0.5.

4. The exhaust gas treatment system of claim 1, wherein cerium is present in the close-coupled vanadium-containing SCR catalyst composition in a Ce:V molar ratio of 0.3 to 0.7.

5. The exhaust gas treatment system of claim 1, wherein the close-coupled vanadium-containing SCR catalyst composition is provided as an extruded porous substrate or a washcoat on a porous substrate.

6. The exhaust gas treatment system of claim 5, wherein the extruded porous substrate or the porous substrate is a honeycomb monolith substrate.

7. The exhaust gas treatment system of claim 1, wherein the close-coupled vanadium-containing SCR catalyst composition comprises a titania-based catalyst support material.

8. The exhaust gas treatment system of claim 1, wherein the one or more downstream PGM-containing oxidation catalyst compositions are provided as an extruded porous substrate or a washcoat on a substrate.

9. The exhaust gas treatment system of claim 1, wherein the one or more downstream PGM-containing oxidation catalyst composition(s) are provided on and/or in the same substrate as the close-coupled vanadium-containing SCR catalyst composition forming a single catalyst article, wherein the substrate has an inlet end, an outlet end and an axial length.

10. The exhaust gas treatment system of claim 9, wherein the close-coupled vanadium-containing SCR catalyst composition is arranged in a first region and the one or more downstream PGM-containing oxidation catalyst composition(s) is arranged in a second region, wherein the first region is spaced apart from the second region.

11. The exhaust gas treatment system of claim 9, wherein the first region extends from the inlet end and wherein the second region extends from the outlet end, wherein the first region extends along between 10% and 90% of the axial length of the substrate, and the second region extends along between 10% and 90% of the axial length of the substrate.

12. The exhaust gas treatment system of claim 9, wherein the first and second regions do not overlap such that there is a gap along the axial length of the substrate between the first and second regions, wherein the first region is a first layer and wherein the second region is a second layer.

13. The exhaust gas treatment system of claim 12, further comprising a covering layer extending from the outlet end over at least part of the second region, wherein the covering layer comprises a SCR catalyst composition.

14. The exhaust gas treatment system of claim 9, wherein the first region is a first layer and wherein the second region is a second layer, wherein the first and second regions are spaced apart from each other by an intervening layer extending between the first and second layers, wherein the intervening layer comprises a SCR catalyst composition.

15. The exhaust gas treatment system of claim 14, wherein the first layer overlaps with the second layer.

16. The exhaust gas treatment system of claim 1, wherein the close-coupled vanadium-containing SCR catalyst composition and the one or more PGM-containing oxidation catalyst compositions are provided on separate substrates thereby forming a close-coupled vanadium-containing SCR catalyst article and one or more PGM-containing oxidation catalyst articles, wherein the close-coupled vanadium-containing SCR catalyst article is spaced apart from the one or more PGM-containing oxidation catalyst articles.

17. The exhaust gas treatment system claim 1, wherein the downstream PGM-containing oxidation catalyst composition(s) comprise an ASC composition and a DOC composition, wherein the ASC composition is upstream of the DOC composition.

18. The exhaust gas treatment system of claim 1, further comprising a downstream SCR catalyst composition downstream of the one or more PGM-containing oxidation catalyst composition(s), optionally wherein the one or more PGM-containing oxidation catalyst composition(s) and the downstream SCR catalyst composition are in an SCRT® configuration.

19. The exhaust gas treatment system of claim 1, wherein the one or more downstream PGM-containing oxidation catalyst composition(s) further comprise a Cu-zeolite, wherein the Cu-zeolite is a small-pore zeolite, preferably wherein the Cu-zeolite has a CHA or AEI-type framework structure.

20. A combustion and exhaust treatment system, comprising:
a lean burn combustion engine; and
the exhaust gas treatment system of claim 1.
